(19) United States
(12) Patent Application Publication
(10) Pub. No.: US 2025/0380103 A1
(43) Pub. Date: Dec. 11, 2025

(54) AUDIO GENERATION

(71) Applicant: Nokia Technologies Oy, Espoo (FI)

(72) Inventors: Tapani PIHLAJAKUJA, Espoo (FI); Miikka Tapani VILERMO, Tampere (FI); Arto Juhani LEHTINIEMI, Tampere (FI)

(21) Appl. No.: 19/217,209

(22) Filed: May 23, 2025

(30) Foreign Application Priority Data
Jun. 7, 2024 (GB) 2408114.3

(51) Int. Cl. H04S 7/00

(52) U.S. Cl. CPC H04S 7/302; H04S 2400/11; H04S 2400/13

(57) ABSTRACT

An apparatus, method and computer program is described comprising: receiving one or more near-field audio source signals from one or more near-field microphones; providing one or more near-field noise signals; receiving a far-field audio signal from an array comprising one or more far-field microphones, wherein the far-field audio signal includes audio components from the one or more near-field audio source signals and the one or more near-field noise signals; and determining room impulse filter responses for the one or more near-field audio source signals and the one or more near-field noise signals.

### FIELD

This specification relates to processing audio signals and, more specifically, to room impulse filter responses.

### BACKGROUND

Audio systems can be used to mix captured audio signals, where the audio signals include audio captured from both near-field microphones and far-field microphones. The effect of a recording space on array can be modelled using one or more room impulse response filters (RIRs).

### SUMMARY

In a first aspect, this specification describes an apparatus comprising: means for receiving one or more near-field audio source signals from one or more near-field microphones; means for providing one or more near-field noise signals (e.g. virtual noise signals); means for receiving a far-field audio signal from an array comprising one or more far-field microphones, wherein the far-field audio signal includes audio components from the one or more near-field audio source signals and the one or more near-field noise signals; and means for determining room impulse filter responses for the one or more near-field audio source signals and the one or more near-field noise signals. The means for determining room impulse filer responses may comprise a recursive least squares (RLS) module, although alternative solutions are possible. For example, room impulses may be detected using an RLS method (e.g. in realtime) or using least squares (LS) estimation (e.g. frame-by-frame).

Some embodiments may comprise means for generating a residual output signal. Alternatively, or in addition, some embodiments may comprise means for generating an ambient signal. In some embodiments, the one or more near-field noise signals may include a feedback component derived from the residual output signal. Furthermore, there may be provided means for modifying the residual output signal in order to generate said feedback component, wherein said modifying the residual output signal comprises one or more of whitening, normalizing and de-correlating.

In embodiments comprising means for generating a residual output signal, the residual output signal may comprise subtracting the near field audio source and noise signals, as operated on by the respective room impulse filter responses, from the received far-field audio signal.

In embodiments comprising means for generating an ambient signal, generating the ambient signal may comprise summing the near-field noise signals, as operated on by the respective room impulse filter responses, and the residual signal. Alternatively, or in addition, generating the ambient signal may comprise subtracting the near-field audio source signals, as operated on by the respective room impulse filter responses, from the received far-field audio signal.

Some embodiments may further comprise means for receiving or obtaining the one or more near-field noise signals. The noise signals may be stored in a memory (e.g. a pre-trained database). The noise signals may be stored, for example, as so-called noise kernels. The use of pre-optimised and stored noise kernel(s) may be advantageous for quality purposes.

The one or more near-field noise signals may comprise multiple noise sources, wherein at least some of the multiple noise sources have different properties (such as different frequency spectrums and/or different energy profiles).

At least one of the near-field noise signals may have an energy profile in which energy decreases with increasing frequency. For example, at least one of the near-field noise signals may be pink noise. Other noise profiles are possible (e.g. white noise, noise with a specific phase spectrum, or known noise sources signals, such as signals related to modelling diffuse sound components).

Some embodiments may further comprise means for analysing (e.g. using a spatial conference estimate and/or a diffuseness extractor) diffuse and directive signal components of one or more of the noise signals as operated on by the respective room impulse filter response, a/the ambient signal and a/the residual output signal with coherence analysis. In some embodiments, extracted diffuse streams of the noise signals as operated on by the respective room impulse filter response, the ambient signal and/or the residual output signal may be combined to create a single diffuse stream and directive components of the noise signals as operated on by the respective room impulse filter response, the ambient signal and/or the residual output signal may be combined to create a single directive ambience stream. Individual direct and diffuse streams may, for example, be separately encoded and rendered, for example using a six degrees-of-freedom rendering means.

Some embodiments may further comprise means for separating coherent and diffuse signals to generate two or more noise kernels.

The means for determining room impulse filter responses may comprise a regular least squares module.

The means for determining room impulse filter responses may determine a room impulse response for each of the one or more near-field audio source signals and each of the one or more near-field noise signals.

The means may comprise: at least one processor; and at least one memory including computer program code, the at least one memory and the computer program code configured, with the at least one processor, to cause the performance of the apparatus.

In a second aspect, this specification describes a method comprising: receiving one or more near-field audio source signals from one or more near-field microphones; providing one or more near-field noise signals; receiving a far-field audio signal from an array comprising one or more far-field microphones, wherein the far-field audio signal includes audio components from the one or more near-field audio source signals and the one or more near-field noise signals; and determining room impulse filter responses for the one or more near-field audio source signals and the one or more near-field noise signals.

The method may comprise generating a residual output signal. Alternatively, or in addition, the method may comprise generating an ambient signal.

The one or more near-field noise signals may include a feedback component derived from the residual output signal. Moreover, the method may further comprise modifying the residual output signal in order to generate said feedback component, wherein said modifying the residual output signal comprises one or more of whitening, normalizing and de-correlating.

The one or more near-field noise signals may comprise multiple noise sources, wherein at least some of the multiple noise sources have different properties (such as different frequency spectrums and/or different energy profiles).

The method may further comprise analysing diffuse and directive signal components of one or more of the noise signals as operated on by the respective room impulse filter response, a/the ambient signal and a/the residual output signal with coherence analysis.

The method may further comprise separating coherent and diffuse signals to generate two or more noise kernels.

In a third aspect, this specification describes any apparatus configured to perform any method as described with reference to the second aspect.

In a fourth aspect, this specification describes computer-readable instructions which, when executed by computing apparatus, cause the computing apparatus to perform any method as described with reference to the second aspect.

In a fifth aspect, this specification describes a computer program comprising instructions for causing an apparatus to perform at least the following: receiving one or more near-field audio source signals from one or more near-field microphones; providing one or more near-field noise signals; receiving a far-field audio signal from an array comprising one or more far-field microphones, wherein the far-field audio signal includes audio components from the one or more near-field audio source signals and the one or more near-field noise signals; and determining room impulse filter responses for the one or more near-field audio source signals and the one or more near-field noise signals.

In a sixth aspect, this specification describes a computer-readable medium (such as a non-transitory computer readable medium) comprising program instructions stored thereon for performing at least the following: receiving one or more near-field audio source signals from one or more near-field microphones; providing one or more near-field noise signals; receiving a far-field audio signal from an array comprising one or more far-field microphones, wherein the far-field audio signal includes audio components from the one or more near-field audio source signals and the one or more near-field noise signals; and determining room impulse filter responses for the one or more near-field audio source signals and the one or more near-field noise signals.

In a seventh aspect, this specification describes an apparatus comprising: at least one processor; and at least one memory including computer program code which, when executed by the at least one processor, causes the apparatus to: receive one or more near-field audio source signals from one or more near-field microphones; provide one or more near-field noise signals; receive a far-field audio signal from an array comprising one or more far-field microphones, wherein the far-field audio signal includes audio components from the one or more near-field audio source signals and the one or more near-field noise signals; and determine room impulse filter responses for the one or more near-field audio source signals and the one or more near-field noise signals.

In an eighth aspect, this specification describes an apparatus comprising: one or more near-field microphones for receiving one or more near-field audio source signals; a first control module for one or more near-field noise signals; an array of one or more far-field microphones for receiving a far-field audio signal, wherein the far-field audio signal includes audio components from the one or more near-field audio source signals and the one or more near-field noise signals; and a second control module for determining room impulse filter responses for the one or more near-field audio source signals and the one or more near-field noise signals.

The apparatus may further comprise a third control module for generating a residual output signal. Alternatively, or in addition, the apparatus may further comprise a fourth control module means for generating an ambient signal.

Generating the residual output signal may comprise subtracting the near field audio source and noise signals, as operated on by the respective room impulse filter responses, from the received far-field audio signal.

Generating the ambient signal may comprises one of: summing the near-field noise signals, as operated on by the respective room impulse filter responses, and the residual signal; and subtracting the near-field audio source signals, as operated on by the respective room impulse filter responses, from the received far-field audio signal.

The one or more near-field noise signals may include a feedback component derived from the residual output signal. Furthermore, the apparatus may further comprise a fifth control module for modifying the residual output signal in order to generate said feedback component, wherein said modifying the residual output signal comprises one or more of whitening, normalizing and de-correlating.

The apparatus may further comprise a noise signal module for receiving or obtaining the one or more near-field noise signals. The noise signals (e.g. noise kernels) may be stored in a memory (such as a database).

The one or more near-field noise signals may comprise multiple noise sources, wherein at least some of the multiple noise sources have different properties.

At least one of the near-field noise signals may have an energy profile in which energy decreases with increasing frequency.

The apparatus may further comprise an analysing module (such as a spatial conference estimator and/or diffuseness extractor) for analysing diffuse and directive signal components of one or more of the noise signals as operated on by the respective room impulse filter response, a/the ambient signal and a/the residual output signal with coherence analysis. Further, extracted diffuse streams of the noise signals as operated on by the respective room impulse filter response, the ambient signal and/or the residual output signal may be combined to create a single diffuse stream and directive components of the noise signals as operated on by the respective room impulse filter response, the ambient signal and/or the residual output signal may be combined to create a single directive ambience stream.

The apparatus may further comprise a noise kernel generator for separating coherent and diffuse signals to generate two or more noise kernels.

The second control module may comprise a regular least squares module.

The second control module may determine a room impulse response for each of the one or more near-field audio source signals and each of the one or more near-field noise signals.

### BRIEF DESCRIPTION OF THE DRAWINGS

So that the invention may be fully understood, embodiments thereof will now be described with reference to the accompanying drawings, in which:

FIG. 1 is a block diagram of an audio system in accordance with an example embodiment;

FIG. 2 is a block diagram of an audio processing system in accordance with an example embodiment;

FIG. 3 is a block diagram of a system in accordance with an example embodiment;

FIG. 4 is a flow chart showing an algorithm in accordance with an example embodiment;

FIG. 5 is a block diagram of an audio system in accordance with an example embodiment;

FIG. 6 is a block diagram of an audio processing system in accordance with an example embodiment;

FIG. 7 is a flow chart showing algorithm in accordance with an example embodiment;

FIG. 8 is a graph in accordance with an example embodiment;

FIG. 9 is a block diagram of an audio processing system in accordance with an example embodiment;

FIG. 10 is a flow chart showing an algorithm in accordance with an example embodiment;

FIG. 11 is a block diagram of a system in accordance with an example embodiment;

FIG. 12 is a flow chart showing an algorithm in accordance with an example embodiment;

FIG. 13 is a block diagram of a system in accordance with an example embodiment; and

FIGS. 14A and 14B show tangible media, respectively a removable memory unit and a compact disc (CD) storing computer-readable code which when run by a computer perform operations according to example embodiments.

### DETAILED DESCRIPTION

In the description and drawings, like reference numerals refer to like elements throughout.

Embodiments described herein relate to the use of audio signals received from one or more near-field microphone(s) and from a one or more far-field microphone(s). Example near-field microphones include Lavalier microphones, which may be worn by a user to allow hands-free operation, or a handheld microphone, or the audio could come directly from a musical instrument (e.g. electric guitar's pick-up), or digital instrument (synthesizer/computer etc) case directly from the audio output, or instruments' PA loudspeaker. In some embodiments, at least some of the near-field microphones may be location tagged. The near-field signals obtained from near-field microphones may be termed “dry signals”, in that they have little influence from the recording space and have relatively high signal-to-noise ratio (SNR).

Far-field microphones are microphones that are located relatively far away from a sound source. In some embodiments, an array of far-field microphones may be provided, for example in a mobile phone or in a Nokia OzoAudio® or similar audio recording apparatus. Devices having multiple microphones may be termed multi-channel devices and can detect an audio mixture comprising audio components received from the respective channels.

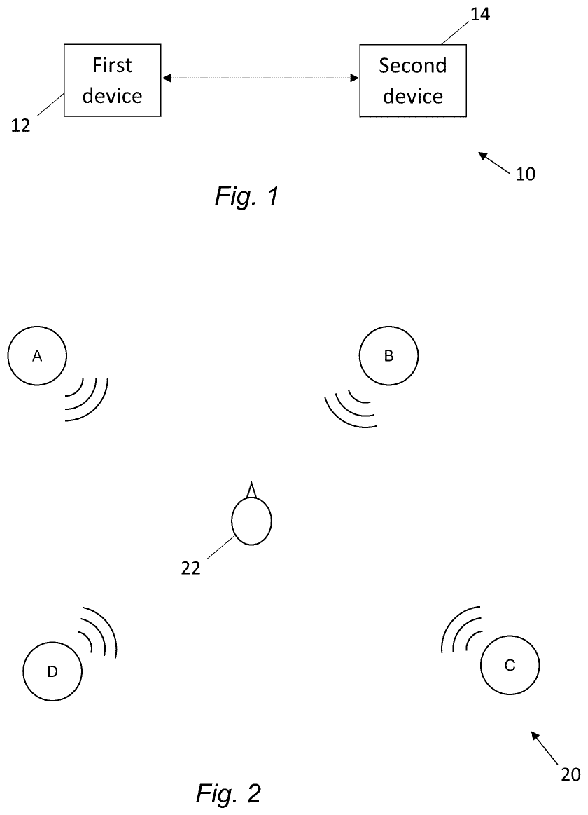

FIG. 1 is a block diagram of an audio system, indicated generally by the reference numeral 1, in accordance with an example embodiment.

The audio system 1 comprises an array of far-field microphones 2 (e.g. Eigenmike ambisonics microphones, mobile phones with spatial capture capability, a stereophonic video/audio capture device or similar recording apparatus such as the Nokia Ozo® and a plurality of near-field microphones (such as wired or wireless Lavalier microphones) that may be worn by a user, such as a singer or an actor. The plurality of near-field microphones comprises a first wireless microphone 4a, a second wireless microphone 4b and a third wireless microphone 4c. The wireless microphones 4a to 4c are in wireless communication with first to third wireless receivers 6a to 6c respectively. A keyboard 8 is also provided within the audio system 1, the keyboard having an audio output system 9.

The audio system 1 comprises an audio mixer 10 that is controlled by a mixing engineer 12. The audio mixer receives audio inputs from the array of far-field microphones 2, the wireless receivers 6a to 6c (providing near-field audio data) and keyboard 8.

The far-field microphones 2 detect audio data in the recording area received, for example, from the audio sources also detected by the near-field microphones 4a to 4c, the keyboard output as output by the audio output system 9 and any ambient sounds.

The microphone signals from far-field microphones (such as the far-field microphones 2) may be termed “wet signals”, in that they have significant influence from the recording space (for example from ambience, reflections, echoes, reverberation, and other sound sources). Wet signals tend to have relatively low SNR. In essence, the near-field and far-field signals are in different “spaces”, near-field signals in a “dry space” and far-field signals in a “wet space”.

When the originally “dry” audio content from the sound sources reaches the far-field microphone array, the audio signals have changed because of the effect of the recording space. That is to say, the signals become “wet” and have a relatively low SNR. The near-field microphones 4a to 4c are much closer to the sound sources than the far-field microphone array. This means that the audio signals received at the near-field microphones are much less affected by the recording space. The dry signals have much higher signal to noise ratio and lower cross talk with respect to other sound sources. Therefore, the near-field and far-field signals are very different and mixing the two (“dry” and “wet”) may result in audible artefacts or non-natural sounding audio content.

The effect of a recording space to the signals detected at the array of far-field microphones 2 can be modelled using a room impulse response (RIR) filter. In addition to near-field microphone signals, the far-field microphone captured signals also contain other sound sources and diffuse ambience which typically cannot be modelled by the estimated RIR filter(s), when applied only to the capture close-field signals. A residual signal (as discussed further below) can be calculated by subtracting all close-field captured signals filtered with the corresponding RIR filters. If all major sound sources are properly captured by the close-field microphones, then the residual has relatively low energy and should contain only relatively uncorrelated noise sources, such as air conditioning noise and the longest reverb tails.

FIG. 2 is a block diagram of an audio processing system, indicated generally by the reference numeral 20, in accordance with an example embodiment.

The system 20 comprises an array of near-field microphones 22 (similar to the microphones 4a to 4c described above), an array of far-field microphones 23 (similar to the microphone array 2 described above) and may include other audio sources 24 (such as the keyboard 8 and audio output system 9 described above). The system 20 also comprises a processor 25 and an RIR database 26. Audio signals from the audio sources 22, 23 and 24 are provided to the processor 25. The processor 25 implements an RIR filter in conjunction with an RIR database 26 and provides a suitably filtered audio output. The processor may implement RIR filtering for a variety of purposes. For example, converting the “dry” signals from the near-field microphones 22 into the “wet” space of the audio from the far-field microphones 23 may enable mixing of the near-field and far-field audio sources (for example, under the control of the mixing engineer 12). Moreover, a residual signal can be calculated by subtracting all of the near-field captured audio signals (filtered by the RIR filter) from the far-field audio signal.

The following is a description of one way in which far-field audio signals may be processed to obtain a short-time Fourier transform (STFT). The far-field microphone arrays 23 comprising an array (e.g. spatial capture device with more than 3 microphones) composed of microphones with indexes (c=1, . . . , C) captures a mixture p=1, . . . , P source signals x^{(p)}(n) sampled at discrete time instances indexed by n and convolved with their room impulse responses (RIR). The sound sources are moving and have time-varying mixing properties, denoted by RIRs h_{cn}^{(p)}(τ), for each channel c at each time index n. Some of the sources (e.g. speaker, car, piano or any sound source) have lavalier microphones close to them. The resulting mixture signal can be given as:

$${y}_{c} ( n ) = {\sum }_{p = 1}^{P} {\sum }_{τ} {x}^{( p )} ( n - τ ) {h}_{cn}^{( p )} ( τ ) + {n}_{c} ( n ) \qquad ( 1 )$$

wherein:
y_{c}(n) is the audio mixture in time domain for each channel index c of the far-field audio recording device 2, i.e. the signal received at each far-field microphone;
x^{(p)} is the p^{th} near-field source signal in time domain (source index p);
h_{cn}^{(p)}(τ) is the partial impulse response in time domain (sample delay index τ), i.e. the room impulse response;
n_{c}(n) is the noise signal in time domain.

Applying the short time Fourier transform (STFT) to the time-domain array signal allows expressing the capture in time-frequency domain as:

$${y}_{ft} = {\sum }_{p = 1}^{P} {{\sum }^{D - 1}}_{d = 0} {h}_{ftd}^{( p )} {x}_{ft - d}^{( p )} + {n}_{ft} = {\sum }_{p = 1}^{P} {\hat{x}}_{ft}^{( p )} + {n}_{ft} \qquad ( 2 )$$

wherein:
y_{ft} is the STFT of the array mixture (frequency and frame index f,t);

$${x}_{ft}^{( p )}$$

is the STFT of pth near-field source signal (p);

$${h}_{ftd}^{( p )}$$

is the room impulse response (RIR) in STFT domain (frame delay index d);

$${\hat{x}}_{ft}^{( p )}$$

is the STFT of pth reverberated (filtered/projected) source signal;
n_{ft}ft is the STFT of the noise signal.

The STFT of the array signal is denoted by y_{ft}=[y_{ft1}, . . . , y_{ftC}]^{T} where f and t are frequency and time frame index, respectively. The source signal as captured by the array is modeled by convolution between the source

$$S T F T {x}_{ft}^{( p )}$$

and its frequency domain RIR

$${h}_{ftd}^{( p )} = {[ {h}_{ftd 1} , … , {h}_{ftdC} ]}^{T} .$$

The length of the convolutive frequency domain RIR is D frames which can vary from few frames to several tens of frames depending on the STFT window length and maximum effective amount of reverberation components in the environment. Please note that this model differs greatly from the usual assumption of instantaneous mixing in frequency domain with mixing consisting of complex valued weights only for the current frame. The additive uncorrelated noise is denoted by n_{ft}=[n_{ft1}, . . . , n_{ftC}]^{T}. The reverberated source signals are denoted by

$${\hat{x}}_{ft}^{( p )} .$$

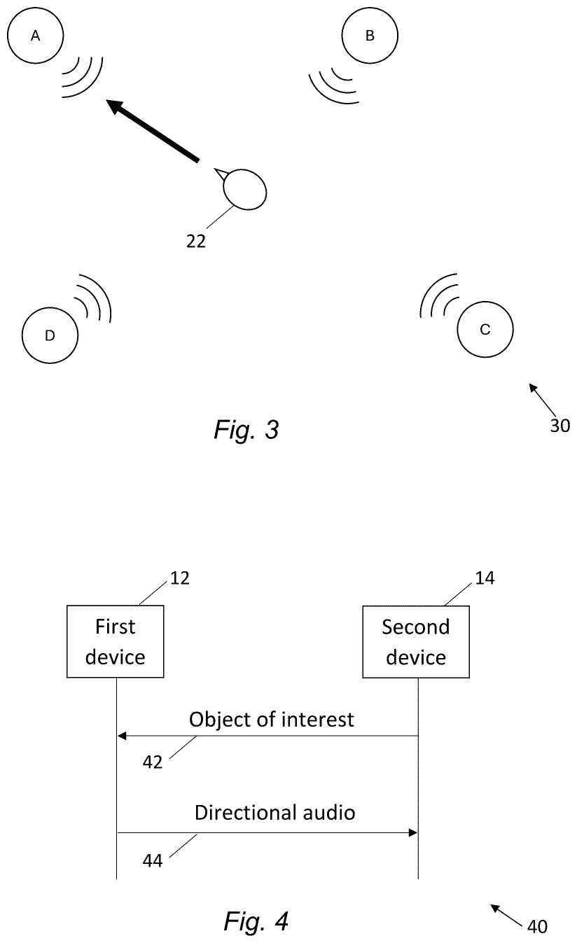

FIG. 3 is a block diagram of a system, indicated generally by the reference numeral 30, in accordance with an example embodiment. The system 30 comprises a first STFT module 31, a second STFT module 32, a voice activity detection (VAD) module 33 (or signal activity detection (SAD)), an RIR estimation module 34, a convolution/projection module 35 and a removal module 36.

As shown in FIG. 3, the first STFT module 31 receives inputs from close-field source capture(s) x^{(p)}(n), e.g. those sources that have Lavalier microphones and the second STFT module 32 receives input from far field array signal(s) y_{c}(n) e.g. OZO microphone signals (or, of course, any relevant array microphone signals).

The system 30 can account for some time differences between the close-field (LAV) and far-field (OZO) signals, however, if the differences are large (e.g. several hundreds of milliseconds or more) a rough alignment may be implemented.

The VAD or SAD module 33 receives signals from the close-field signal in order to determine when the RIR estimate is to be updated (by the RIR estimation module 34), i.e., if a source does not emit any signal its RIR is not estimated. Both STFTs y_{ft} and x_{(ft)}^{(p)} are inputs to an RIR estimation module 34 by recursive least squares (RLS) algorithm for real time operation mode (discussed further below).

The RIRs estimated are convolutive in the STFT domain, i.e. the filter coefficients span over several STFT frames and RIR for each frequency index is estimated individually (by convolution/projection module 35). This strategy makes the individual filters to consist of only several tens of coefficients making their estimation more robust, while when combined by inverse STFT the filters span several hundreds of milliseconds. This may be provided to accurately model sound propagation in environments with reverberation times up to several seconds. The estimation criterion is formulated as least squares criterion of the residual after removing the filtered sources (using the removal module 36) from the mixture. The mathematical formulation can be interpreted as projecting the close-field signal to far-field signal space, hence the term projection is used (see module 35) to describe the entire process hereafter. As a result, a set of RIR filters in STFT domain are obtained. As a result, a set of RIR filters in time-frequency domain are obtained.

The obtained RIR may be applied to the original close-field signal (as discussed above with reference to FIG. 2). After applying the RIR the close-field signal can finally be added or subtracted (either in time or in time-frequency domain) to/from the array signal(s). In this way the influence of the sources can be increased or decreased/removed in the mixture signal to produce the ambience/residual signal. Additionally, the estimated RIRs are outputted for subsequent processing steps, such as parametrization of the RIRs for tasks of changing listening position (e.g. in 6DoF audio) or encoding of the RIRs for transmission.

FIG. 4 is a flow chart showing an algorithm, indicated generally by the reference numeral 40, in accordance with example embodiment. The algorithm 40 provides an example arrangement for obtaining RIR filter parameters in accordance with various embodiments. The algorithm 40 starts at operation 42.

At operation 44, an audio signal y_{c} (n) is received from the far-field microphone array 23. At operation 46 an audio signal x^{(p)}(n) is received from the near-field audio microphone array 22 for those sound sources provided with a near-field audio recording device (such as the devices 4a, 4b and 4c described above).

During operation 46, the location of a relevant mobile source may be determined. The location can be determined using information received from a tag with which the mobile source is provided. Alternatively, the location may be calculated using multilateration techniques described below.

At operation 48, a short-time Fourier transform (STFT) is applied to both far-field and near-field audio signals. Alternative transforms may be applied to the audio signals as described below.

In some embodiments, time differences between the near-field and far-field audio signals can be taken into account. However, if the time differences are large (e.g. several hundreds of milliseconds or more) a rough alignment may be carried our prior to the process commencing. For example, if a wireless connection between a near-field microphone and RIR processor causes a delay, the delay may be manually fixed by delaying the other signals in the RIR processor or by an external delay processor which may be implemented as hardware or software.

A signal activity detection (SAD) may be estimated from the near-field signal in order to determine when the RIR estimate is to be updated. For example, if a source does not emit any signal over a time period, its RIR value does not need to be estimated. At operation 50, RIR filter values are determined (or estimated). The STFT values y_{ft} and

$${x}_{ft}^{( p )}$$

are input to an RIR estimator module that may form part of the processor 25. The RIR estimation may be performed using a block-wise linear least squares (LS) projection in offline operation mode, that is where the RIR estimation is performed as part of a calibration operation. Alternatively, a recursive least squares (RLS) algorithm for real time operation mode, that is where the RIR estimation occurs during a performance itself. In other embodiments, the RLS algorithm may be used in offline operation instead of the block-wise linear LS algorithm. In any case, as a result, a set of RIR filters in time-frequency domain are obtained.

The RIR filter values determined in operation 50 may be used in operation 52. The algorithm 40 ends at operation 54.

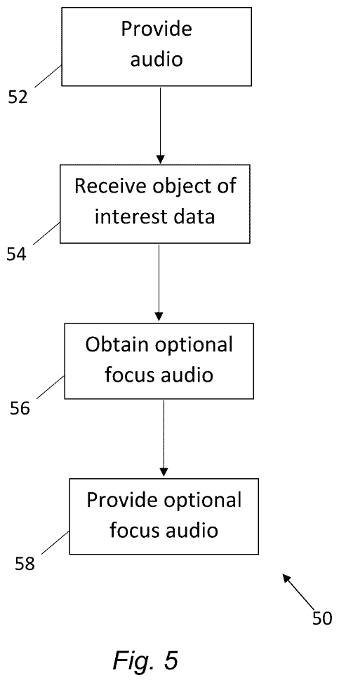

FIG. 5 is a block diagram of an audio system, indicated generally by the reference numeral 60, in accordance with an example embodiment.

The audio system 60 comprises the array of far-field microphones 2, the plurality of near-field microphones 4a, 4b and 4c, the first to third wireless receivers 6a to 6c, the keyboard 8 having an audio output system 9, the audio mixer and the mixing engineer 12 described above with reference to the audio system 1.

The system 60 also comprises one or more near-field noise sources 62. As indicated in FIG. 5, the noise source(s) 62 are injected virtual sound sources that are detected by the far-field microphones 2.

Thus, the far-field microphones 2 detect audio data in the recording area received, for example, from the audio sources also detected by the near-field microphones 4a to 4c, the keyboard output as output by the audio output system 9, noise from the noise source(s) 62, and any ambient sounds.

The effect of a recording space to the noise signal(s) detected at the array of far-field microphones 2 can be modelled using a room impulse response (RIR) filter, as discussed above.

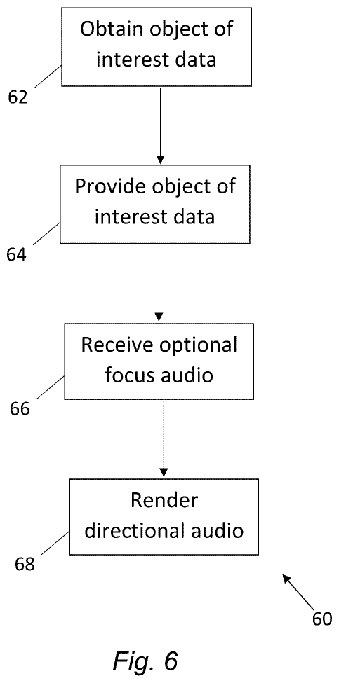

FIG. 6 is a block diagram of an audio processing system, indicated generally by the reference numeral 70, in accordance with an example embodiment.

The system 70 comprises an array of near-field microphones 72 (similar to the array 22 described above), an array of far-field microphones 73 (similar to the array 23 described above). The array of near-field microphones includes an input from noise kernels 71 (similar to the noise sources 62 described above). The outputs of the array 72 and array 73 are provided to a pre-processing module 74 (which may be optional). The output of the pre-processing module 74 is provided to an RLS processing module 76. The pre-processing module 74 and RLS processing module 76 may be implemented by the processor 25 of the system 20 described above.

The RLS processing module 76 processes the audio data, including filtering using an RIR filter.

Thus, the near-field noise sources 62 and 71 (e.g. a virtual noise source) are injected into the RIR estimation process. Adding the noise source can enable an improve estimate of a residual signal, since the significant unknown sound source can be modelled and thus removed from the residual signal noise source. “Better” ambience in this context may mean that the ambience contains as little as possible identifiable sound sources and has relatively low signal energy level compared to the captured real sound sources or the injected noise sources.

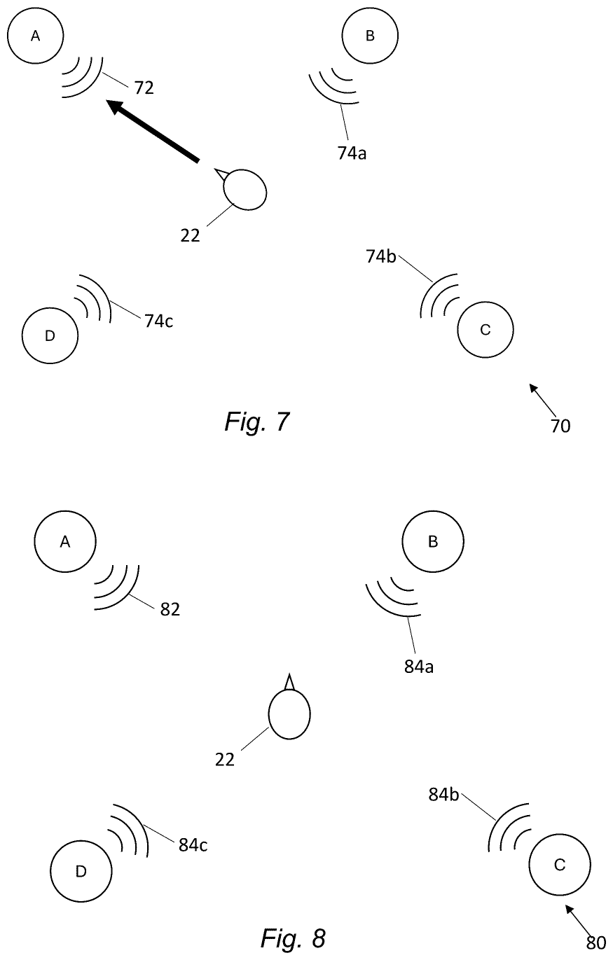

FIG. 7 is a flow chart showing algorithm, indicated generally by the reference numeral 80, in accordance with example embodiment. The algorithm 80 may be implemented by the system 70 described above.

As shown in FIG. 7, near-field audio signal are received in operation 82. The near-field audio signals may be received from the first, second and third wireless microphones 4a, 4b and 4c (as part of the near field microphone array 72). Noise signals are provided (for example the noise kernels 71) at operation 84. Far-field audio signals are received at operation 86 (for example, from the far-field array 73). Finally, RIR values are determined (for example by the RLS processing module 76) in operation 88.

Thus, statistical noise signals (i.e. noise kernels) are created and fed into the RIR estimation algorithm for modelling diffuse and ambient sound components. The injection of noise kernels into an RLS algorithm may avoid modelling diffuse sounds using the real close-field captured signals. The process described with reference to FIGS. 6 and 7 may improve residual signal extraction quality by reducing the mismatch in the RIR estimation criterion (e.g. residual least squares minimisation) if the amount of the diffuse signal components are prominent in the captured far-field audio signal. With the noise kernel injection, the RIR estimation algorithm is able to model diffuse and ambient components. In the residual signal creation, the projected noise kernels need not be removed from the mixture, potentially resulting in a more realistic ambient signal extraction (wherein the ambient signal is the sum of the residual signal and the reverberated noise kernels).

As described further below, the noise kernels can be, for example: white noise, pink noise, noise with specific phase spectrum, or known noise source signals from database, etc. that are related to modelling diffuse sound components (ideal spatial coherence function of diffuse sounds depends on the array microphone distances and rigid body of the array, e.g. spherical microphone array). The noise kernels may come from a pre-trained database. The number and type of noise kernels can be varied, and in general more noise kernels Q all with different random phase can capture more diverse diffuse sounds. By way of example, FIG. 8 is a graph, indicated generally by the reference numeral 90, showing a frequency spectrum for an example pink noise injection that may be used in an example embodiment.

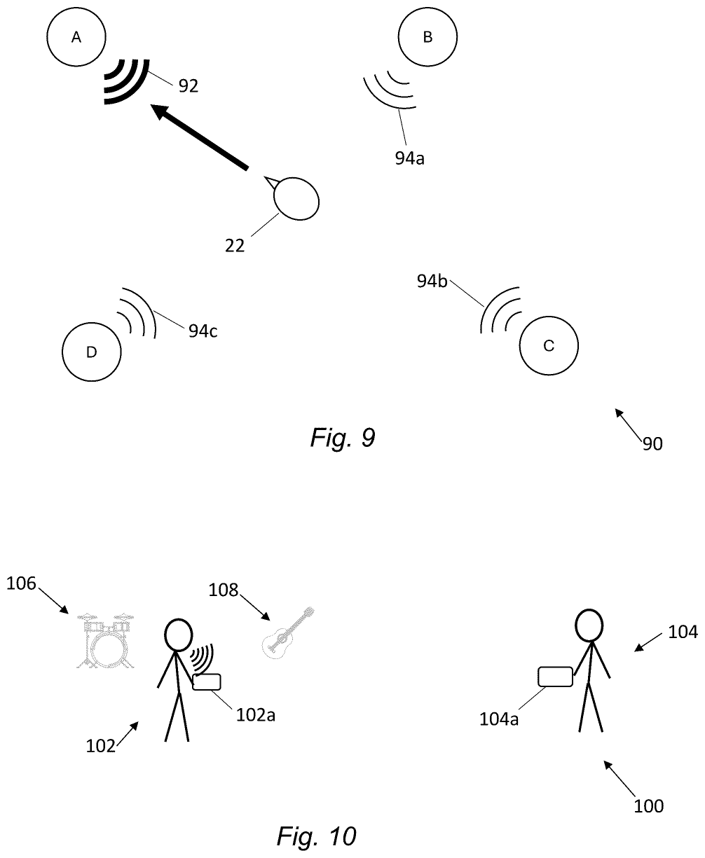

FIG. 9 is a block diagram of an audio processing system, indicated generally by the reference numeral 100, in accordance with an example embodiment. The system 100 includes the array of near-field microphones 72, the array of far-field microphones 73, the pre-processing module 74 (which may be optional) and the RLS processing module 76 described above with reference to FIG. 6. In addition, the system 100 comprises a noise generator 102 and a residual processing module 104.

As described further below, the noise generator 102 provides noise signals to the array of near-field microphones 72 and the residual processing module receives a residual output signal from the RLS processing module 76, processes the residual output and feeds back the processed residual signal to the noise generator 102.

FIG. 10 is a flow chart showing an algorithm, indicated generally by the reference numeral 110, in accordance with an example embodiment. The algorithm 110 may be implemented by the system 100.

The algorithm 110 starts at operation 112, where a residual output is generated (for example by the RLS processing module 76). The residual output undergoes processing in operation 114; for example, the residual signal (as provided by the RLS processing module 76) may be whitened and normalized, also modification of the residual signal phase by de-correlation can be used (in order to avoid error feedback overfit, for example). In operation 116, the processed residual signal is fed back to the noise generator (e.g. the noise generator 102).

In this way, the system 100 can be used to reduce the number of injected noise kernels by providing indirect feedback of the residual output. The residual feedback injection (as provided to the noise generator 102) generally provides better adaptation to an unknown ambient feedback.

In a further variant, the projected noise kernels and the residual signal (e.g. after removal of real sources and projected noise kernels from the mixture) can both contain diffuse signal components, which can be analysed and extracted using spatial coherence based diffuseness estimation. In this arrangement, all projected noise kernels and the residual may be analysed using a spatial coherence estimator and diffuseness extractor. The extracted diffuse streams of all the projected noise kernels and the residual signal may be combined to create single diffuse stream and directive components combined to a single directive ambience stream. The individual direct and diffuse streams can be separately encoded and rendered using a 6DoF spatial renderer program/device. Thus, the spatial property of coherence may be taken into account when generating noise kernels. This may potentially improve the performance of the noise insertion.

Aspects of example implementations of the systems 1, 20, 30, 60, 70 and 100 and the algorithms 40, 80, 110 and 130 described herein are provided below by way of example.

### Online RIR Estimation by RLS Algorithm

In real time operation the RIR filter weights vary for each time frame t and we assume availability of p=1, . . . , \hat{P} close-field source signals (\hat{P}≤P). Assuming that the mixing model in equation (2) is uncorrelated across frequencies then the RIR weights can be estimated independently for each frequency. By omitting the channel dimension (process repeated independently for all channels), the filtering equation for the \hat{P} known signals in time frame t and at frequency index f is specified as

$${\hat{x}}_{ft} = {\sum }_{p = 1}^{\hat{P}} {\sum }_{d = 0}^{D - 1} {x}_{ft - d}^{( p )} {h}_{ftd}^{( p )} = {x}_{ft}^{T} {h}_{ft} \qquad ( 3 )$$

The vector variables

$${x}_{ft}^{T} ∈ {ℂ}^{\hat{P} D \times 1}$$

and h_{ft}∈ [symbol] ^{β}^{_{D×1}} contain the source signals and filter coefficients as stacked and can be specified as,

$${x}_{ft} = {[ {x}_{ft}^{( 1 )} , {x}_{ft - 1}^{( 1 )} , … , {x}_{ft - D - 1}^{( 1 )} , … , {x}_{ft}^{( \hat{P} )} , {x}_{ft - 1}^{( \hat{P} )} , … , {x}_{ft - D - 1}^{( \hat{P} )} ]}^{T} ,$$

and for the filter coefficients as,

$${h}_{ft} = {[ {h}_{ft 0}^{( 1 )} , {x}_{ft 1}^{( 1 )} , … , {h}_{ftD - 1}^{( 1 )} , … , {h}_{ft 0}^{( \hat{P} )} , {h}_{ft 1}^{( \hat{P} )} , … , {h}_{ftD - 1}^{( \hat{P} )} ]}^{T} .$$

For notational simplicity and since the RIR estimation by RLS algorithm is applied individually for all frequencies, we omit the frequency index f during following explanation of the general RLS algorithm. Efficient real-time operation can be achieved with recursive estimation of the RIR filter weights hₜ using the recursive least squares (RLS) algorithm. The modelling error at time step t is specified as:

$${e}_{t} = {y}_{t} - {\hat{x}}_{t} \qquad ( 4 )$$

where yₜ is the observed/desired mixture signal. The cost function to be minimized with respect to filter weights is:

$$C ( {h}_{t} ) = {\sum }_{i = 0}^{t} {λ}^{t - i} {e}_{i}^{2} , 0 < λ < 1 \qquad ( 5 )$$

which accumulates the estimation error from past frames with exponential weight λ^{t-i}. The weight of the cost function can be thought of as a forgetting factor which determines how much past frames contribute to the estimation of the filter weights at current frame. In literature RLS with λ<1 is sometimes called to as exponentially weighted RLS and when λ=1 it is referred to as growing window RLS.

The RLS algorithm minimizing equation (5) is based on recursive estimation of the inverse correlation matrix Pₜ of the close-field signal and the optimal filter weights hₜ and can be summarized as:

### Initialization:

$$\begin{matrix}{h}_{0} = 0 \\ {P}_{0} = {δ}^{- 1} I\end{matrix}$$

Repeat for t=1, 2, . . .

$$\begin{matrix}{α}_{t} = {y}_{t} - {x}_{t}^{T} {h}_{t - 1} \\ {g}_{t} = {P}_{t - 1} {x}_{t}^{*} \frac{1}{λ + {x}_{t}^{T} {P}_{t - 1} {x}_{t}^{*}} \\ {P}_{t} = \frac{1}{λ {P}_{t - 1}} - \frac{1}{λ {g}_{t} {x}_{t}^{T} {P}_{t - 1}} \\ {h}_{t} = {h}_{t - 1} + {α}_{t} {g}_{t}\end{matrix} \qquad ( 6 )$$

The initial regularization of the inverse autocorrelation matrix is achieved by defining S using a small positive constant, typically from 10⁻² to 10¹. Small δ causes faster convergence whereas larger δ constraints the initial converge to happen over longer time period (few seconds).

With the above definitions the standard RLS algorithm can be used to jointly estimate all close-field signal RIRs simultaneously, which greatly improves the estimation accuracy by preventing overfitting and using all available information of the sources.

The contribution of past frames to the RIR filter estimate at current frame t can be varied over frequency f. Small changes in source position can cause substantial changes in the RIRs at high frequencies due to highly reflected and more diffuse sound propagation path, and therefore the contribution of past frames at high frequencies may be lower than compared to low frequencies. It is assumed that the RIR parameters slowly change at lower frequencies and source evidence can be integrated over longer periods, meaning that the exponential weight λ^{t-i} can have substantial values for frames up to 1.5 seconds in past. In contrast, past frames only up to 0.5 or 0.8 seconds can be reliably used to update the filter weights at high frequencies, and the error weight should be close to zero for frames older than that.

### Regularized RLS Algorithm

A regularized RLS algorithm can be used to improve the robustness of RIR estimation, as described further above. In order to specify regularization of the RIR filter estimates, the RLS algorithm is given in a direct form, i.e. without using matrix inversion lemma to derive update directly to the inverse autocorrelation matrix Pₜ but for the autocorrelation matrix Rₜ (Rₜ⁻¹=Pₜ). The formulation can be found for example from T. van Waterschoot, G. Rombouts, and M. Moonen, “Optimally regularized recursive least squares for acoustic echo cancellation,” in Proceedings of The second annual IEEE BENELUX/DSP Valley Processing Symposium (SPS-DARTS 2006), Antwerp, Belgium, 2005, pp. 28-29. The direct form RLS algorithm updates are specified as:

### Initialization:

$$\begin{matrix}{h}_{0} = 0 \\ {P}_{0} = {δ}^{- 1} I\end{matrix}$$

Repeat for t=1, 2, . . .

$$\begin{matrix}{α}_{t} = {y}_{t} - {x}_{t}^{T} {h}_{t - 1} \\ {R}_{t} = λ {R}_{t - 1} + {x}_{t}^{*} {x}_{t}^{T} \\ {h}_{t} = {h}_{t - 1} + {R}_{t}^{- 1} {x}_{t}^{*} {α}_{t}\end{matrix} \qquad ( 7 )$$

The above algorithm would give the exact same result as the one described above, but requires operation for calculating the inverse of the autocorrelation matrix, and is thus computationally more expensive, but in return allows regularization of it.

The autocorrelation matrix update with Levenberg-Marquardt regularization (LMR), as described in T. van Waterschoot, G. Rombouts, and M. Moonen, “Optimally regularized recursive least squares for acoustic echo cancellation,” in Proceedings of The second annual IEEE BENELUX/DSP Valley Processing Symposium (SPS-DARTS 2006), Antwerp, Belgium, 2005, pp. 28-29. according to [3] is:

$${R}_{t} = λ {R}_{t - 1} + {x}_{t}^{*} {x}_{t}^{T} + ( 1 - λ ) diag ( {b}_{t} ) I , \qquad ( 8 )$$

where diag(bₜ) denotes diagonal matrix with vector bₜ on its main diagonal. The regularization weights bₜ [symbol] ^{\hat{P}D×1} are defined as,

$${b}_{t} = [ {\underbrace{{b}_{t}^{( 1 )} , … , {b}_{t}^{( 1 )}}}_{D} , … , {\underbrace{{b}_{t}^{( \hat{P} )} , … , {b}_{t}^{( \hat{P} )}} {]}^{T}}_{D} , \qquad ( 9 )$$

Another type of regulation type of regularization is the Tikhonov regularization (TR), corresponding to L₂ regularization in regular Least Squares formulation, which can defined for the RLS algorithm as described in João F. Santos and Tiago H. Falk, “Blind room acoustics characterization using recurrent neural networks and modulation spectrum dynamics,” AES 60TH INTERNATIONAL CONFERENCE, 2016:

$${R}_{t} = λ {R}_{t - 1} + {x}_{t}^{*} {x}_{t}^{T} + ( 1 - λ ) diag ( {b}_{t} ) I \qquad ( 10 )$$

$${h}_{t} = {h}_{t - 1} + {R}_{t}^{- 1} ( {x}_{t}^{*} {α}_{t} + ( 1 - λ ) diag ( {b}_{t} ) {h}_{t - 1} ) \qquad ( 11 )$$

### Example Implementation of the RLS Regularization

The regularization of the filter update in RLS algorithm allows improving RIR estimation robustness from numerous perspectives. Firstly, the regularization can be used to avoid general overfitting by penalizing and regularizing excess filter weights by estimating average RMS level difference in the source close-field signal and far-field mixture. Secondly, regularization can be used in avoiding projecting cross-talk signal components present in the close-field microphones, especially in low frequencies. The close-field microphones are generally not directive at low frequencies and can pick up low-frequency signal content from noise or other sources. Additionally, since the RIR estimation of multiple sources is formulated as a joint optimization problem, there is need to control the update of specific elements

$${h}_{f t d}^{( p )}$$

within h_{ft} in case of momentary or long period of silence of subset of sources.

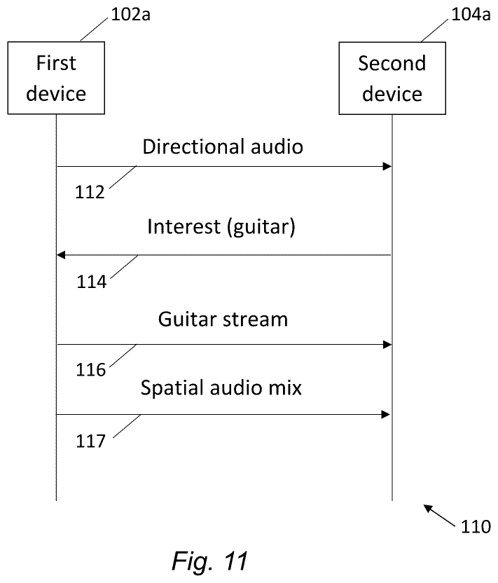

FIG. 11 is a block diagram of a system, indicated generally by the reference numeral 120, of an exemplary implementation of the pre-processing module 74 of the systems 70 and 100 described above. The system 120 is provided for controlling regularization, source activity detection and routing of the pre-processing module 74. In the following sections, we will break down the frequency dependent regularization weights

$${b}_{ft} = {[ {\underbrace{{b}_{ft}^{( 1 )} , ... , {b}_{ft}^{( 1 )}}}_{D} , ... , {\underbrace{{b}_{ft}^{( \hat{P} )} , ... , {b}_{ft}^{( \hat{P} )}}}_{D} ]}^{T} , \qquad ( 12 )$$

into a signal RMS level dependent part

$${a}_{t}^{( p )} ,$$

a close-field relative spectrum dependent part

$${c}_{f t}^{( p )}$$

and global regularization constant σ so that

$${b}_{ft}^{( p )} = σ {a}_{t}^{( p )} {c}_{ft}^{( p )} .$$

### Signal RMS Level-Based Regularization

First the frame RMS of the input signal STFTs is calculated as:

$$RMS [ {x}_{f} ] = {( \frac{1}{F} {\sum }_{f} {\vert {x}_{f} \vert}^{2} )}^{1 / 2} .$$

The amount of regularization needed is dependent on how much attenuation or amplification on average is required between close-field and far-field signals. For this we use overall signal RMS level ratio between the close-field signal

$${x}_{f t}^{( p )} ,$$

and the far-field signal y_{ft} (for a single channel c) estimated recursively as,

$${L}_{t}^{( p )} = γ {L}_{t - 1}^{( p )} + ( 1 - γ ) RMS [ {x}_{ft}^{( p )} ] / RMS [ {y}_{ft} ] \qquad ( 13 )$$

where γ controls the amount of recursion, i.e. that the RMS estimate does not react too fast for rapid changes in RMS ratio. We store the maximum observed value of

$${L}_{t}^{( p )}$$

since from the start of the processing denoted as

$${L}_{max}^{( p )} = {max}_{0 < {t}^{′} < t} [ {L}_{{t}^{′}}^{( p )} ] .$$

The amount of regularization is set to

$${a}_{t}^{( p )} = {L}_{max}^{( p )}$$

which denotes maximum observed RMS ratio. For example, if

$${L}_{t}^{( p )} = 1 ( 0 dB )$$

it indicates that the signals have same overall RMS level.

### Relative Spectrum Based Regularization

The close-field signal

$${x}_{ft}^{( p )}$$

can have very low energy at certain frequencies and practically no evidence of it can be observed in the mixture y_{ft}. This applies especially to musical instruments. Additionally, the close-field signal might have some cross-talk component particularly in low-frequencies that can become projected with high filter gains if the relative spectrum of the source is not taken into account in the regularization.

In order to avoid updating the filter coefficients with relatively weak energy, we use a source spectrum based regularization. We keep short-term average statistics of the close-field signal magnitude spectrum

$${m}_{ft}^{( p )} = {\sum }_{{t}^{′} = t - M}^{t} \vert {x}_{{ft}^{′}}^{( p )} \vert ,$$

where M denotes the number of averaged frames. The spectrum based regularization given current processed frequency f is defined as

$${c}_{ft}^{( p )} = 1 - log 10 ( {m}_{ft}^{( p )} / {max}_{f} [ {m}_{ft}^{( p )} ] ) \qquad ( 14 )$$

The frequency index with most energy in the short-term average spectrum results to

$${c}_{ft}^{( p )} = 1$$

whereas frequencies with lower energy have

$${c}_{ft}^{( p )} > 1$$

in logarithmic relation. The developed relative spectrum based regularization is effective avoiding projecting possible cross-talked content with low energy with respect to actual signal components. Additionally, the low-frequency cross-talk projection is restricted by the global regularization constant σ which is set so that it increases towards low frequencies in logarithmic relation and in general low frequency signal components will in general have larger regularization.

### Source Activity Detection

For the source activity detection we calculate recursively smoothed estimate of the RMS level of the close-field signals calculated as

$${\hat{L}}_{t}^{( p )} = γ {\hat{L}}_{t - 1}^{( p )} + ( 1 - γ ) RMS [ {x}_{ft}^{( p )} ] \qquad ( 15 )$$

We store the minimum RMS value observed as from the beginning of processing

$$( {\hat{L}}_{max}^{( p )} = {min}_{0 < {t}^{′} < t} [ {\hat{L}}_{{t}^{′}}^{( p )} ] )$$

which acts as noise floor estimate for each close-field microphone, assuming that source is momentarily silent. We use 3 dB detection threshold above the noise floor (2*\hat{L}) to set the source active.

The activity information is used to either pass on the regularization without modification or in order to avoid updating RIR of inactive source p at time step t the respective regularization weights regularization is set to very high, for example,

$${b}_{ft}^{( p )} = 100 {a}_{t}^{( p )} {c}_{ft}^{( p )} .$$

This effectively halts the update of the filter weights when the second term in Equation (8) is very large and the inverse of Rₜ end up having very small effect in filter weights update in (7) leading to h_{ft}≈h_{ft-1}.

### Filtering Operation and Implementation Parameters

The RLS algorithm may be applied independently for all frequencies of the input STFTs to obtain

$${h}_{ftd}^{( p )}$$

and the reverberated sources can be obtained as,

$${\hat{x}}_{ft}^{( p )} = {\sum }_{d = 0}^{D - 1} {x}_{ft - d}^{( p )} {h}_{ftd}^{( p )} , p ∈ [ 1 , … , \hat{P} ] \qquad ( 16 )$$

Time-domain signals can be reconstructed by inverse FFT and overlap-add synthesis. The modifications of the mixture signal using the reverberated sources is linear additive operation and can be done in either STFT or time-domain.

Typical implementation parameters with STFT window length set to 1024 samples with 50% frame overlap are as follows. The forgetting factor was set to λ=0.98 for 0 Hz and it linearly decreases to 0.95 for Fs/2=24 kHz. The chosen values correspond to error accumulation extending to past 1.5 seconds for 0 Hz and past 0.8 seconds for 24 kHz. Recursion factor for RMS level ratio was set to γ=0.97 and the global regularization constant σ=10-4. If the source is inactive regularization is set as

$${b}_{ft}^{( p )} = 100 {a}_{t}^{( p )} {c}_{ft}^{( p )} .$$

It is understood that different values can be used.

### Noise Kernel Injection

The regular RLS algorithm applied for RIR estimation of known close-field signals neglects the effect of the noise term n_{ft} from the following mixing model (same as Equation (2)),

$${y}_{ft} = {\sum }_{p = 1}^{P} {\sum }_{d = 0}^{D - 1} {h}_{ftd}^{( p )} {x}_{ft - d}^{( p )} + {n}_{ft}$$

When the error criterion specified in Equation (5) is used, the RLS algorithm aims at minimizing least squares criterion of the residual leading to removal of all content and zero residual in ideal situation. For example, transient sounds in close-field signals x_{ft}^{(p)} occupying all frequencies allows the RIRs to momentarily model all mixture content with linear operator (RIR) and it causes sudden removal of all ambient information from the residual signal. Also, non-transient sources with cross-talked noise can cause removal of unnecessary content from the mixture if the RIR parameter regularization is not optimal and allows substantially large amplification of the noise in the dry source signal.

The ambient signal components and diffuse noise in the mixture can be modelled using a filtering model specified as:

$${\hat{x}}_{tf} = {\sum }_{p = 1}^{\hat{P}} {\sum }_{d = 0}^{D - 1} {x}_{ft - d}^{( p )} {h}_{ftd}^{( p )} + {\sum }_{q = 1}^{\hat{Q}} {\sum }_{d = 0}^{D - 1} {n}_{ft - d}^{( q )} {\hat{h}}_{ftd}^{( q )} \qquad ( 17 )$$

where

$${n}_{t}^{( q )}$$

are the “dry” domain noise signals q=1, . . . \hat{Q}, referred to as noise kernels, and

$${\hat{h}}_{ftd}^{( q )}$$

are their associated RIRs. The RIRs are not restricted to modelling only directive, point-like sources, but can as well represent acoustic propagation channels of diffuse sounds.

In theory, the diffuse signals have specific coherence function between two channels determined by the distance of the microphone and the body of the array (for example rigid sphere). The coherence function can be thought to be represented by the RIR, whereas the signals kernels of the diffuse ambience can be assumed to have random phase and magnitude (white noise). Thus, the exact knowledge of the noise kernels is not required and any signal type with statistically random phase can be used.

With notation of

$${x}_{tf}^{( \hat{P} + q )} = {n}_{ft}^{( q )} and {h}_{ftd}^{( \hat{P} + q )} = {\hat{h}}_{ftd}^{( q )}$$

the filtering model in Equation (17) can be arranged in such way that the noise kernels can be regarded as part of the close-field signals,

$${\hat{x}}_{tf} = {\sum }_{p = 1}^{\hat{P} + \hat{Q}} {\sum }_{d = 0}^{D - 1} {x}_{ft - d}^{( p )} {h}_{td}^{( p )} \qquad ( 18 )$$

which further allows recasting the problem of RIR estimation of real close-field signals and any number of noise kernels as joint estimation of RIR coefficients of the conventional form (equation 3),

$${\hat{x}}_{ft} = {x}_{ft}^{T} {h}_{ft} \qquad ( 19 )$$

where the vector variables

$${x}_{ft}^{T} ∈ {ℂ}^{\hat{P} \hat{Q} D \times 1}$$

and h_{ft}∈ [symbol] ^{\hat{P}\hat{Q}D×1} contain the source and noise signals and their associated filter coefficients as stackedAspecified as,

$${x}_{ft} = {[ {x}_{ft}^{( 1 )} , … , {x}_{ft - D - 1}^{( 1 )} , … , {x}_{ft}^{( \hat{P} )} , … , {x}_{ft - D - 1}^{( \hat{P} )} , {n}_{ft}^{( 1 )} , … , {n}_{ft - D - 1}^{( 1 )} , … , {n}_{ft}^{( \hat{Q} )} , … , {n}_{ft - D - 1}^{( \hat{Q} )} ]}^{T} ,$$

and for the filter coefficients as,

$${h}_{ft} = {[ {h}_{ft 0}^{( 1 )} , … , {h}_{ft D - 1}^{( 1 )} , … , {h}_{ft 0}^{( \hat{P} )} , … , {h}_{ft D - 1}^{( \hat{P} )} , {\hat{h}}_{ft 0}^{( 1 )} , … , {\hat{h}}_{ftD - 1}^{( 1 )} , … , {\hat{h}}_{ft 0}^{( \hat{Q} )} , … , {\hat{h}}_{ftD - 1}^{( \hat{Q} )} ]}^{T} .$$

The above formulation makes the noise injected RIR estimation become jointly optimized with the real close-field signal RIR estimation and makes the implementation of regular version fully identical to the noise injected one (only one implementation for one platform/device/dsp).

The true residual signal, i.e. also removing the reverberated injected noise signals can be obtained as:

$${r}_{f t} = {y}_{t f} - {\sum }_{p = 1}^{\hat{P} + \hat{Q}} {\sum }_{d = 0}^{D - 1} {x}_{t f - d}^{( p )} {h}_{f t d}^{( p )} \qquad ( 20 )$$

Usually only one ambient signal A_{ft} for 6DoF rendering is outputted, which can be obtained as sum of the residual and the projected noises (p=\hat{P}+1, . . . , \hat{P}+\hat{Q}) or alternatively all reverberated real close-field captured sources removed from the mixture

$${A}_{f t} = {r}_{f t} + {\sum }_{p = \hat{P} + 1}^{\hat{P} + \hat{Q}} {\sum }_{d = 0}^{D - 1} {x}_{f t - d}^{( p )} {h}_{f t d}^{( p )} = {y}_{t f} - {\sum }_{p = 1}^{\hat{P}} {\sum }_{d = 0}^{D - 1} {x}_{f t - d}^{( p )} {h}_{f t d}^{( p )} \qquad ( 21 )$$

As described above, the noise kernels can be for example: white noise, pink noise, noise with specific phase spectrum, or known noise source signals from database, etc. that are related to modelling diffuse sound components (ideal spatial coherence function of diffuse sounds depends on the array microphone distances and rigid body of the array, e.g. spherical microphone array). The number and type of noise kernels can be varied, and in general more noise kernels \hat{Q} all with different random phase can capture more diverse diffuse sounds.

The noise kernels may be are fed as close-field input signals to the algorithm and go through all the same regularization heuristics blocks as the regular source signals, with the exception that their activity detection is always set to 1 (always active). This requires just one parameter signalling indicating which of the total p=1, . . . , \hat{P}+\hat{Q} sources are the noise kernels. Also, the user set parameters for the injected noise kernels require in general shorter RIR lengths in terms of STFT frames.

### Residual Feedback Injection

In order to model all ambient content in the mixture of very reverberant space, the noise kernel injection algorithm described above may require injecting multiple noise kernels with different random or determined phase spectrum. However, the residual of the algorithm without noise kernel injection already contains information about the ambience and diffuse sounds. The residual feedback injection provides better adaptation to unknown ambient environment, while the processing requires heavy regularization of the feedback signal RIR estimation and modification of the fed back signal (whitening and decorrelation) to avoid error feedback overfit.

In order to reduce the number of different injected noise kernels and automatic adjustment to current operation environment the proposed processing in the residual feedback injection algorithm involves indirect feedback of the RLS algorithm unmixing residual to the input of the RIR estimation. The residual for new frame t can be produced by assuming no update on the RIR filters and subtracting all reverberated source signals from the mixture, i.e. filtering operation in Equation (20) before update of the RIR

$${h}_{f t d}^{( p )}$$

for any of the sources in current most recent time frame t.

The residual signal r_{ft} by equation (20) cannot be directly fed back to the algorithm input because of two strong feedback and algorithm output converging towards trivial solution of RIR r_{ft}=y_{ft} and

$${h}_{f t d}^{( p )} = 0$$

for any real sources. We propose following steps for modification of the fed back residual signal and strong regularization of its RIR coefficients.

The residual signal can be first whitened (flatten the spectrum) or have short terms average spectrum similar to pink noise. Also modification of residual signal phase by decorrelation can be used to avoid exact phase matching to the mixture.

### Diffuse and Direct Ambience Stream Combination

The diffuse and directive signal components analysis is based on spatial coherence, which is used to separate the diffuse and directive streams of the ambience signal. If the ambient residual signal obtained in the algorithms described above contains some signal components from the directive close-field captured sources, their rendering as part of the ambience can reduce the subjective quality of the possible re-positioned sound sources (spatial cue mismatch caused by the ambience). Only the fully diffuse ambience signal can be encoded and transmitted.

The proposed diffuseness extraction is based on spatial coherence calculated from the multichannel ambience signal. We specify the spatial coherence as cross-spectral density divided with the powers spectral densities defined for signals X and Y from two microphones/sensors as

$${γ}_{X Y} = \frac{X * Y}{\sqrt{{XX}^{*} {YY}^{*}}} \qquad ( 22 )$$

The diffuseness of the signals captured by the two microphones is an inverse of the spatial coherence defined as

$${ψ}_{X Y} = 1 - {γ}_{X Y} \qquad ( 23 )$$

The spatial coherence in Equation (22) is calculated for each time-frequency point of the multichannel STFT domain ambience A_{ft}=[A_{ft1}, . . . , A_{ftC}] with time window of J frames. Additionally, the spatial coherence and diffuseness is calculated for all unique channel pairs cᵢ, cⱼ i≠j, i.e. for ftth time-frequency point between channel c=1 and c=2 signals are defined as X=A_{ft′c}|_{c=1, t′=t-J . . . t} and Y=A_{ft′c}|_{c=2, t′=t-J . . . t}.

We denote the obtained diffuseness at each TF-point of each unique pair (i,j) as

$${Ψ}_{f t}^{( i , j )}$$

the final overall diffuseness of the multichannel ambience signal is obtained as average over all channel pairs (i,j)

$${Ψ}_{f t} = 1 / {N}_{c} {\sum }_{( i , j )} {Ψ}_{f t}^{( i , j )} \qquad ( 24 )$$

where N_{C} denotes the number of unique microphone pairs in the array capture.

Since the value range of diffuseness estimator in Equation (24) is between [0,1], it can be directly used as a mask for extracting diffuse and directive parts of ambience. We define the diffuse ambient STFT signal as:

$${A}_{f t}^{d i f f} = {Ψ}_{f t} ⊙ {A}_{f t} \qquad ( 25 )$$

where ⊙ denotes element wise product (over the channel dimension of A_{ft}). The inverse mask is used to obtain the directive part of the ambient signal defined as:

$${A}_{f t}^{d i r} = ( 1 - {Ψ}_{f t} ) ⊙ {A}_{f t} \qquad ( 26 )$$

Additionally, the equivalence

$${A}_{f t} = {A}_{f t}^{d i f f} + {A}_{f t}^{d i r}$$

holds, i.e. original ambience can be restored in full. Time-domain diffuse and directive ambience signals can be reconstructed by inverse FFT and overlap-add synthesis.

Thus, in the case of multichannel signal capture, (e.g. an array microphone, as descried herein), the received signals between any pair of microphones may have strong correlation (called coherence). This in practice means that sound field is arriving from a single direction and is arriving to microphones at slight time and phase difference. On the other hand, if there is only little correlation between channel pairs, the signal is coming from many directions. In that case the sound field is called diffuse and there is no coherence between signals. These properties can be used to generate two noise kernels that seek to mimic properties of the coherent (directional) and diffuse (coming from all directions) signals.

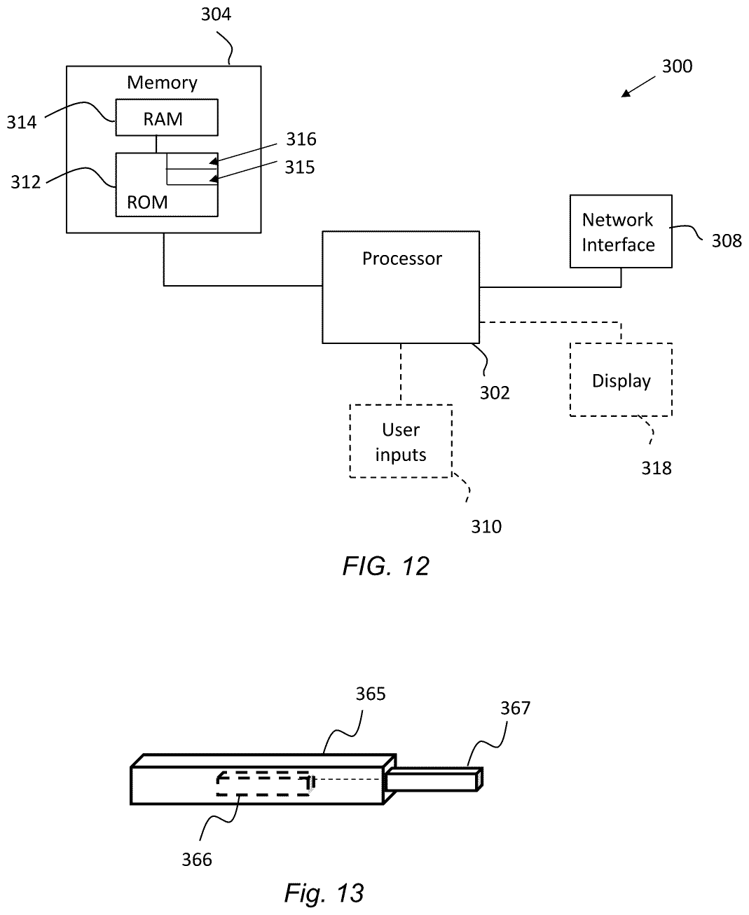

By way of example, FIG. 12 is a flow chart showing an algorithm, indicated generally by the reference numeral 130, in accordance with an example embodiment. The algorithm 130 may be used to separate coherent and diffuse signals to generate two noise kernels.

The algorithm 130 starts at operation 132, where a multi-channel ambience signal is obtained. At operation 134, the coherence and/or diffuseness of the ambience signal is determined. At operation 136, noise kernels (e.g. two noise kernels) are generated, whose spectral properties represent either the coherent signal properties and diffuse signal spectral properties.

For completeness, FIG. 13 is a schematic diagram of components of one or more of the example embodiments described previously, which hereafter are referred to generically as processing systems 300. A processing system 300 may have a processor 302, a memory 304 closely coupled to the processor and comprised of a RAM 314 and ROM 312, and, optionally, user input 310 and a display 318. The processing system 300 may comprise one or more network/apparatus interfaces 308 for connection to a network/apparatus, e.g. a modem which may be wired or wireless. Interface 308 may also operate as a connection to other apparatus such as device/apparatus which is not network side apparatus. Thus direct connection between devices/apparatus without network participation is possible.

The processor 302 is connected to each of the other components in order to control operation thereof.

The memory 304 may comprise a non-volatile memory, such as a hard disk drive (HDD) or a solid state drive (SSD). The ROM 312 of the memory 314 stores, amongst other things, an operating system 315 and may store software applications 316. The RAM 314 of the memory 304 is used by the processor 302 for the temporary storage of data. The operating system 315 may contain code which, when executed by the processor implements aspects of the algorithms 40, 80, 110 and 130 described above. Note that in the case of small device/apparatus the memory can be most suitable for small size usage i.e. not always hard disk drive (HDD) or solid state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

FIGS. 14A and 14B show tangible media, respectively a removable memory unit 365 and a compact disc (CD) 368, storing computer-readable code which when run by a computer may perform methods according to example embodiments described above. The removable memory unit 365 may be a memory stick, e.g. a USB memory stick, having internal memory 366 storing the computer-readable code. The memory 366 may be accessed by a computer system via a connector 367. The CD 368 may be a CD-ROM or a DVD or similar. Other forms of tangible storage media may be used. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable storage medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

As used in this application, the term “circuitry” refers to all of the following: (a) hardware-only circuit implementations (such as implementations in only analogue and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a server, to perform various functions) and (c) to circuits, such as a microprocessor(s) or a portion of a microprocessor(s), that require software or firmware for operation, even if the software or firmware is not physically present.

If desired, the different functions discussed herein may be performed in a different order and/or concurrently with each other. Furthermore, if desired, one or more of the above-described functions may be optional or may be combined. Similarly, it will also be appreciated that the flow diagrams of FIGS. 4, 7, 10 and 12 are examples only and that various operations depicted therein may be omitted, reordered and/or combined.

It will be appreciated that the above described example embodiments are purely illustrative and are not limiting on the scope of the invention. Other variations and modifications will be apparent to persons skilled in the art upon reading the present specification.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1-18. (canceled)

19. An apparatus comprising:
at least one processor; and
at least one memory storing instructions that, when executed by the at least one processor, cause the apparatus at least to:
receive object of interest data from a user device identifying one or more objects of interest to a user of the user device; and
provide a directional audio data stream to the user device, wherein the directional audio data stream comprises:
a separate directional audio object stream for one or more of the one or more objects of interest identified in the object of interest data; and
a spatial audio mix for other audio sources.

20. An apparatus as claimed in claim 19, wherein the apparatus is further caused to generate the directional audio data stream.

21. An apparatus as claimed in claim 19, wherein the apparatus is further caused to receive a request for focused audio data, wherein the directional audio data stream is provided in response to the request.

22. An apparatus as claimed in claim 21, wherein the object of interest data is received as part of the request for focused audio data.

23. An apparatus as claimed in claim 19, wherein the user device is a user equipment of a mobile communication system.

24. An apparatus as claimed in claim 19, wherein the directional audio object stream has a higher relative bit rate allocation than the spatial audio mix.

25. An apparatus as claimed in claim 19, wherein the directional audio data stream comprises Immersive Voice and Audio Services data.

26. An apparatus comprising:
at least one processor; and
at least one memory storing instructions that, when executed by the at least one processor, cause the apparatus at least to:
provide object of interest data to an audio transmitting device, wherein the object of interest data identifies one or more objects of interest to a user of the user device;
receive a directional audio data stream from the audio transmitting device, wherein the directional audio data stream comprises: a separate directional audio object stream for one or more of the one or more objects of interest identified in object of interest data available to the audio transmitting device at the time of generating the directional audio stream; and a spatial audio mix for other audio sources; and
render directional audio to the user based on an object of current interest to the user.

27. An apparatus as claimed in claim 26, wherein the apparatus is further caused to amplify the directional audio object stream, relative to the spatial audio mix, for any object of current interest to the user having audio included in the directional audio object stream.

28. An apparatus as claimed in claim 26, wherein the apparatus is further caused to generate the object of interest data.

29. An apparatus as claimed in claim 26, wherein the apparatus is further caused to provide a request for focused audio data, wherein the directional audio data stream is received in response to the request.

30. An apparatus as claimed in claim 29, wherein the object of interest data is provided as part of the request for focused audio data.

31. An apparatus as claimed in claim 26, wherein the apparatus is a user equipment of a mobile communication system.

32. A method comprising:
receiving object of interest data from a user device identifying one or more objects of interest to a user of the user device; and
providing a directional audio data stream to the user device, wherein the directional audio data stream comprises: a separate directional audio object stream for one or more of the one or more objects of interest identified in the object of interest data; and a spatial audio mix for other audio sources.

33. A method as claimed in claim 32, further comprising generating the directional audio data stream.

34. A method as claimed in claim 32, further comprising receiving a request for focused audio data, wherein the directional audio data stream is provided in response to the request.

35. A method as claimed in claim 34, wherein the object of interest data is received as part of the request for focused audio data.

36. A method as claimed in claim 32, wherein the directional audio object stream has a higher relative bit rate allocation than the spatial audio mix.

37. A method as claimed in claim 32, wherein the directional audio data stream comprises Immersive Voice and Audio Services data.
